(19) United States
(12) Patent Application Publication
(10) Pub. No.: US 2014/0100361 A1
(43) Pub. Date: Apr. 10, 2014

(54) EXTRACTION OF CHITINS IN A SINGLE STEP BY ENZYMATIC HYDROLYSIS IN AN ACID MEDIUM

(71) Applicants: IFREMER (INSTITUT FRANCAIS DE RECHERCHE POUR L'EXPLOITATION DE LA MER), Issy-les-Moulineaux (FR); UNIVERSITE DE NANTES, Nantes Cedex 01 (FR); CENTRE NATIONAL DE LA RECHERCHE SCIENTIFIQUE (CNRS, Paris (FR)

(72) Inventors: Karine Le Roux, Milly-la-Foret (FR); Jean-Pascal Berge, Saint-Ave (FR); Regis Baron, La-Chapelle-sur-Erdre (FR); Eric Leroy, Saint-Etienne-de-Montluc (FR); Abdellah Arhaliass, Saint-Nazaire (FR)

(73) Assignee: IFREMER (INSTITUT FRANCAIS DE RECHERCHE POUR L'EXPLOITATION DE LA MER), Issy-les-Moulineaux (FR)

(21) Appl. No.: 14/122,427

(22) PCT Filed: May 25, 2012
(86) PCT No.: PCT/FR2012/051180

§ 371 Date: Nov. 26, 2013

(30) Foreign Application Priority Data
May 26, 2011 (FR) 1154580

(51) Int. Cl. C08B 37/08

(52) U.S. Cl. CPC C08B 37/003
USPC 536/20; 435/274

(57) ABSTRACT

A method of enzymatic extraction of chitin is realized in a single step wherein the chitin is obtained by enzymatic hydrolysis of raw material constituted by animal biomass including chitin, the enzymatic hydrolysis using an enzyme active in acid medium. Also disclosed is a process of optimization of the method of enzymatic extraction of chitin, as well as the chitin susceptible to be obtained by the method of enzymatic extraction.

### FIELD OF INVENTION

The present invention relates to the field of the recovery of biomass, preferably animal biomass, more preferably marine and/or entomological biomass. In particular, the present invention relates to a method for the enzymatic extraction of chitin in a single step, from animal biomass elements comprising chitin, preferably from marine and/or entomological by-products, using an active enzyme in an acid medium.

### BACKGROUND OF INVENTION

The production and consumption of marine products, and particularly of crustaceans, notably prawns, is increasing each year. By-products (heads and shells) generally represent more than 50% of the fresh weight of crustaceans. The use thereof is thus a major issue given the volumes involved and also the slow natural biodegradability thereof. Chitin is the main product derived from these by-products.

Moreover, entomophagy is a common dietary practice in some countries which is tending to develop worldwide. Indeed, insects represent an advantageous dietary resource due to the nutritional qualities thereof. Furthermore, insect production offers a very advantageous environmentally friendly alternative compared to the production of other animal proteins. The by-products obtained from insect protein production include chitin-rich shells, as for crustaceans.

Chitin is the second most plentiful polysaccharide on the surface of the Earth after cellulose. It does not have a single chemical structure, but several, since it includes polysaccharides consisting of N-acetyl-β-D-glucosamine units and D-glucosamine units.

Chitin partially forms the exoskeleton of insects and crustaceans and the wall of fungi and bacteria. Chitin thus represents 20 to 30% of the shells of crustaceans. Besides chitin, the exoskeleton of crustaceans contains 20 to 40% of proteins, 30 to 60% of minerals and 0 to 14% of fat (Waldeck J., Daum G., Bisping B. and Meinhardt F., Appl. Env. Microbiol., 2006, 72 (12), 7879-7885). Chitin thus represents 3 to 60% of the shells of insects. Besides chitin, the exoskeleton of insects contains 20 to 80% of proteins, 1 to 20% of minerals and 10 to 50% of fat (“Forest insects as food: humans bite back”, Proceedings of a workshop on Asia-Pacific resources and their potential for development, 19-21 Feb. 2008, Chiang Mai, Thailand—FAO). Whether for crustaceans or for insects, the proportions of the various constituents vary according to the species, age, genus and may fluctuate according to the seasons and environmental conditions. Chitin extraction conditions should thus be adapted according to the raw material used (Tolaimate A., Desbrieres J., Rhazi M. and Alagui A., Polymer, 2003, 44 (26), 7939-7952).

Chitin is found in crustacean and insect by-products in the form of chitin/proteins/minerals complexes. It is usually extracted in two “chemical extraction” steps:
demineralization by means of acid hydrolysis, to remove minerals; and
deproteinization by means of base hydrolysis, to remove proteins.

Chitin extraction from marine by-products is currently carried out on an industrial scale by means of “chemical extraction”. Chitin extraction from insects has not been very developed to date but has already been the subject of studies, essentially using a chemical process (cicada chitin: Sajomsang W. and Gonil P., Mat. Science Engineering C, 2010, 30(3), 357-363; silkworm pupa chitin: Paulino A., Simionato J., Garcia J. and Nozaki J., Carbohydrate Polymers, 2006, 64, 98-103; bumblebee chitin: Majtan J., Bilikova K., Markovic O., Grog J., Kogan G. and Simuth J., Int. J. Biol. Macromol., 2007, 40, 237-241).

A third optional bleaching step, for example using sodium hypochlorite, is frequently used to remove residual pigments. Washing operations, generally with water, are required between these various steps.

Chitin can then be readily deacetylated, for example using sodium hydroxide, to produce chitosan.

Chitin is conventionally extracted for a wide range of applications: medical, pharmaceutical, dietary, food, technical (water filtration and depollution), etc. Indeed, chitin, chitosan and the derivatives thereof, particularly the oligomers thereof, are biocompatible, biodegradable and non-toxic. The type of application depends on the physicochemical characteristics of chitin and the derivatives thereof. In particular, chitosan may be particularly used for producing mulching film, stomach protection gels, but also for active ingredient encapsulation, waste water filtration, cartilage replacement, tissue regeneration, etc.

Industrial chitin extraction from marine by-products is essentially implemented in emerging countries. Conventional chemical extraction uses large quantities of reagents (essentially hydrochloric acid, sodium hydroxide and bleaching agents) which are harmful for operators, equipment and the environment. Furthermore, the basic deproteinization step is generally performed hot and thus requires a high energy input. Moreover, the washing steps give rise to very large volumes of polluted effluents, which are technically difficult and expensive to recycle.

One of the problems associated with current extraction methods is the possibility of chitin being denatured during the process (Crini G., Badot P. and Guibal E., Chitine et Chitosan. Du polymère à l'application, 2009, Presses Universitaires de Franche-Comté).

Studies have shown that chitin could be extracted using biological methods, notably by means of enzymatic extraction or microbiological fermentation, particularly for the deproteinization step.

Of the research on the fermentation process, the studies conducted by Beaney use the exoskeleton of the Nephrops norvegicus prawn as the study substance (Beaney P., Lizardi-Mendoza J. and Healy M., J. Chem. Tech. Biotech., 2005, 80, 145-150). In this study, chitin is extracted by means of lactic fermentation in the presence of bacterial strains for 5 days at 30° C. The acidification of the medium, due to lactic acid production by the bacteria, results in partial demineralization while the bacteria carry out deproteinization. In this study, the pH decreases to a value of 3.5 after 7 days of fermentation. However, under these conditions, the chitin extracted still contains 13% of proteins and 14% minerals. A purer chitin may then be obtained by performing further chemical treatments. This type of method is thus not suitable for directly obtaining a high-quality chitin, limiting the applications thereof.

A further microbial fermentation study was conducted to extract chitin from red crab shells by co-fermenting the shells in the presence of two bacteria: firstly, Lactobacillus paracasei tolerans KCTC-3074, which is a lactic acid-producing bacterium, and secondly Serratia marcescens FS-3, which is an extracellular protease-producing bacterium (Jung W., Jo G., Kuk J., Kim K. and Park R., Appl. Microbiol. Biotechnol., 2006, 71, 234-237). Co-fermentation was maintained for 7 days at 30° C. and resulted in a demineralization rate of 97.2% and a deproteinization rate of merely 52.6%. The chitin obtained was not characterised in this study but the low deproteinization rate is limiting in terms of the use thereof.

A further microbial fermentation study was conducted by the same team, with a bacterial strain producing proteases for deproteinizing and demineralizing marine by-products (Jo G., Jung W., Kuk J., Oh K., Kim Y. and Park R., Carbohydrate polymers, 2008, 74, 504-508). A fermentation test was conducted for 7 days at 30° C., in the presence of 10% of bacterial strain, and resulted in a deproteinization and demineralization rate of 84% and 47%, respectively. As above, the demineralization is due to the pH decrease over time (pH 5.6 after 7 days of fermentation), associated with bacterial acid production. The low degree of purity of the chitins obtained is limiting in terms of the applications thereof and this method, like the previous method, involves the drawback of requiring a very long reaction time.

The best demineralization and deproteinization yields by means of a two-step fermentation process were obtained by Waldeck (Waldeck J., Daum G., Bisping B. and Meinhardt F., Appl. Env. Microbiol., 2006, 72 (12), 7879-7885). After fermenting for 6 days from 42 to 55° C., followed by a 3hour lactic acid treatment, the residual protein content is less than 10% and the demineralization rate is equal to 98.8%. As in the study by Jo et al., the reaction time is relatively long.

Chitin extraction by means of a fermentation process thus results in a chitin with a higher residual protein content than in the case of chemical extraction and further treatments are frequently required to improve the demineralization. Furthermore, the reaction times are much longer than with the chemical process.

Chitin extraction by means of a biological process may also be performed using enzymatic extraction.

A method for extracting chitin comprising the removal of proteins by means of the enzymatic activity of fish viscera was proposed in the international patent application WO 86/06082. In particular, the method described in this patent application comprises the extraction of chitin from prawn shells by means of demineralization with an acid followed by deproteinization using fish viscera, optionally pre-ensiled at pH 1.2-2.5. The raw material, i.e. the prawn shells, is first ensiled in a sulphuric acid solution. Ensiling makes it possible to store the raw material before use and enables the demineralization thereof. Secondly, the pre-ensiled shells are placed in contact with fish viscera for deproteinization. The characteristics of the chitin obtained using this two-step method are not specified.

Enzymatic extraction may also be performed using a purified enzyme, generally a proteolytic enzyme. This is, for example, the case in the study conducted by N. Gagné, with the use of chymotrypsin or papain for extracting chitin from prawn shells (Gagné N. “Production of chitin and chitosan from crustacean waste and their use as food processing aid”, 1993 McGill University—Montreal, doctoral thesis). After a conventional chemical demineralization step, the proteins present are hydrolysed by the enzymes. The optimal deproteinization conditions particularly involve a pH of 8.0-8.7 for chymotrypsin and papain. Under the conditions used, the residual protein content is very low (1.3% and 2.8% for chymotrypsin and papain, respectively).

The same type of method was used by Synowiecki and Al Khateeb for conducting the enzymatic digestion of prawn shells, previously demineralized with hydrochloric acid, using alcalase, at 55° C. and pH 8.5 (Synowiecki J. and Al Khateeb, Food Chemistry, 2000, 68, 147-152).

A method for producing chitin involving an enzymatic hydrolysis step has been patented (CN1715255). This method offers a general approach for processing the raw material since compounds other than chitin are also extracted from prawn shells. In particular, this method comprises an enzymatic hydrolysis step followed by solvent extract. The solid portion obtained is then placed in the presence of hydrochloric acid to perform demineralization and finish extracting chitin.

All the enzymatic chitin extraction methods currently described involve an independent conventional chemical demineralization step, before or after the enzymatic hydrolysis step. In this way, even if the deproteinization step is carried out using a biological method, there is still a chemical step requiring washing operations and producing polluted effluents and liable to affect the properties of the extracted chitin.

The current methods are thus not satisfactory and there is a need for chitin extraction methods which are simple, rapid, efficient, inexpensive and more environmentally friendly. These methods should be suitable for producing chitins wherein the purity is compatible with use in the food, dietetic or cosmetic industries. Furthermore, the chitins produced should meet the specifications required to be processed into chitosan, oligo-chitosan or glucosamines, etc. In particular, the degree of polymerization of the chitin should be sufficiently high and it should not be denatured during the process.

Moreover, further compounds can potentially be recovered using crustacean and insect by-products, particularly in nutraceuticals, dietetics or cosmetics. Indeed, these marine and insect by-products contain soluble compounds such as lipids, pigments, sugars, mineral salts, amino acids or peptides. Targeted extractions of these soluble compounds have been developed, such as for example the extraction of pigments and in particular of astaxanthin which is used in the food industry (U.S. Pat. No. 7,241,463). However, these methods targeted on soluble compound extraction require further steps to conduct chitin extraction.

In current chitin extraction methods, chitin is obtained in solid form and the liquid extraction phases, containing soluble compounds of potential interest, are not recovered. This lack of recovery can particularly be explained by the poor quality of the soluble compounds present in the liquid phases. Indeed, in these chitin extraction methods, soluble compounds are frequently degraded due to the relatively severe conditions used.

Therefore, there is a need for chitin purification using a method that respects the initial structure thereof more and is also suitable for being associated with soluble product co-extraction.

The Applicant conducted research in order to obtain full recovery of the portions of animal biomass containing chitin, notably full recovery of marine by-products, in particular crustacean shells and entomological biomass, in particular insect shells. In particular, co-extraction methods were studied with a view to the advantages thereof in relation to targeted extractions.

### SUMMARY

The invention thus relates to a method for the enzymatic extraction of chitin, characterised in that said method is carried out in a single step, hereinafter referred to as the “single step”, wherein chitin is obtained by the enzymatic hydrolysis of animal biomass comprising chitin, said enzymatic hydrolysis using an active enzyme in an acid medium.

According to one embodiment, said single step is an enzymatic hydrolysis intended for deproteinizing and demineralizing marine by-products simultaneously.

According to one embodiment, said active enzyme in an acid medium is a protease having a broad spectrum of activity in an acid medium, preferably pepsin or a stable acid protease.

According to one embodiment, the enzyme concentration used for hydrolysis is 0.1 to 75%, preferably 5 to 30%, more preferably from approximately 23 to approximately 27% in weight relative to the weight of the protein mass estimated in the raw material.

According to one embodiment, the acid medium is obtained by means of the presence of an acid, preferably a dietary acid, more preferably phosphoric acid or formic acid.

According to one embodiment, said animal biomass comprising chitin comprises marine by-products, preferably marine by-products obtained from crustaceans, preferably prawns, crabs or krill, or from cephalopods, preferably squid or cuttlefish.

According to one embodiment, said animal biomass comprising chitin comprises insect by-products, preferably insect by-products obtained from beetles or hymenoptera.

According to one embodiment, said method further comprises operations for washing, drying and/or grinding the raw material, preferably water washing, cold drying and/or grinding operations resulting in fragments less than 1 mm in size.

According to one embodiment, said method further comprises reaction medium treatment operations at the end of the enzymatic hydrolysis, said operations comprising operations for separating the solid and liquid phases, rinsing and/or drying the insoluble portion, preferably operations consisting of filtration, rinsing with water and/or oven-drying.

The invention also relates to a method for optimising said method for the enzymatic extraction of chitin, characterized in that said optimization method comprises at least one of the following steps:

a) selecting the pH of the acid medium in the range pH_{enz}±0-2, preferably pH_{enz}±0-1.5, preferably pH_{enz}±0-1, where pH_{enz} is the pH at which the enzyme exhibits maximum activity,

b) selecting the temperature of the acid medium in the range T_{enz}±0-20° C., preferably T_{enz}±0-15° C., preferably T_{enz}±0-10° C., where T_{enz} is the temperature at which the enzyme exhibits maximum activity,

c) determining the mineral and protein content of the raw material,

d) calculating the acid concentration to be used in the reaction medium, according to the mineral content of the raw material, it being understood that, according to one preferred embodiment, the pH is selected such that the reaction medium is maintained throughout the enzymatic hydrolysis at the pH selected in step a),

e) calculating the proportion of enzyme to be used with respect to the protein content of the raw material,

f) determining the reaction time for obtaining chitin or the chitin derivatives sought.

The invention further relates to chitin that can be obtained by means of the method according to the invention.

The invention also relates to chitosan that can be obtained by deacetylating chitin according to the invention.

The invention also relates to a composition comprising chitin according to the invention and/or chitosan according to the invention.

The invention also relates to a pharmaceutical composition comprising chitin according to the invention and/or chitosan according to the invention, a cosmetic composition comprising chitin according to the invention and/or chitosan according to the invention, a medical device comprising chitin according to the invention and/or chitosan according to the invention.

The invention also relates to a food product, a nutraceutical composition, a dietetic composition, a food supplement or a functional food comprising chitin according to the invention and/or chitosan according to the invention.

The invention also relates to a composition comprising chitin according to the invention and/or chitosan according to the invention for the use thereof in water treatment, filtration and/or water depollution.

The invention also relates to a texturing agent comprising chitin according to the invention and/or chitosan according to the invention.

### DEFINITIONS

In the present invention, the following terms are defined as follows:
“Chitin” refers to N-acetyl-glucosamine and glucosamine polysaccharides.
“Chitosan” refers to chitin deacetylation products. The borderline between chitosan and chitin consists of a 50% degree of acetylation: below, the compound is called chitosan, above, chitin.
“Animal biomass” refers to all organic matter of animal origin.
“Marine by-products” refers to parts not used by the food industry in marine products, particularly crustacean shells and heads.
“Entomological by-products” or “insect by-products” refers to parts not used by the food industry in entomological products, particularly insect shells and heads.
“Degree of polymerization” refers to the length of a polymer chain, particularly chitin. The degree of polymerization consists of the number of monomer units forming the polymer chain.
“Crystallinity index” refers to the proportion of material found in the crystalline state.
“Demineralization” refers to a method for removing minerals.
“Deproteinization” refers to a method for removing proteins.
“Depolymerization” refers to the reduction of the length of the polymeric chain of chitin.
“Deacetylation” refers to the removal of acetyl groups and corresponds to the transition from chitin to chitosan.
“Moisture content” refers to the mass percentage of water contained in a sample.
“Protein content” refers to the mass percentage of protein contained in a sample.
“Mineral content” refers to the mass percentage of minerals contained in a sample.
“Chitin content” refers to the mass percentage of chitin contained in a sample.
“Approximately”, placed before a number, means more or less 10% of the nominal value of the number.

Unless specified otherwise, the percentages are mass percentages.

### DETAILED DESCRIPTION

The present invention relates to a method for the enzymatic extraction of chitin in a single step, from a raw material obtained from animal biomass and comprising chitin, preferably a raw material made of marine by-products and/or entomological by-products, using an active enzyme in an acid medium, preferably a protease, the acid used being preferably a dietary acid, this method also being suitable for extracting soluble compounds such as lipids, pigments, sugars, mineral salts, amino acids or peptides.

In the present invention, the two key steps of the conventional method for extracting chitin, i.e. demineralization in an acid medium and deproteinization in an alkaline medium, are merged into a single step. This merging into a single step is enabled through the use of an enzyme wherein the optimal activity pH is acidic: the enzyme performs the deproteinization, while the acidic pH makes it possible to carry out the demineralization simultaneously.

The method according to the invention only comprising a single key step, it offers the advantage of reducing rinsing-related material losses between the two steps of the conventional method. This method also makes it possible to decrease the reagent and solvent consumption and limit polluted effluent production. This method is thus both inexpensive and environmentally friendly.

The conditions used in the method according to the present invention are such that the biological activity of chitins and the native structure thereof are preserved better than in the extraction methods existing to date.

The method according to the present invention offers the advantage of enabling destructuration of the crustacean and/or insect by-product matrix by separating chitin, proteins and minerals, these three major constituents being initially strongly linked.

The method according the invention comprises an enzymatic hydrolysis step in an acid medium performing demineralization and deproteinization simultaneously. The minerals and proteins are detached from the solid phase and carried in the liquid phase.

According to one embodiment, the method according to the present invention may comprise, in addition to the enzymatic hydrolysis step in an acid medium, preparation and processing operations:
preparing the raw material,
preparing a reaction medium according to the optimal conditions for enzymatic activity and comprising at least one acid,
mixing the raw material prepared in the reaction medium, homogenizing and adding enzyme,
enzymatic hydrolysis step with controlled temperature, pH and stirring:

simultaneous deproteinization and demineralization reactions for an optimized time,
separating the soluble and insoluble portions of the “reaction liquor”,
washing the “insoluble” portion, drying and packaging,
optionally, characterising the extracted products.

Raw Material

The term “raw material”, according to the present invention, denotes the animal biomass comprising chitin used for extracting chitin, preferably marine by-products used for extracting chitin and/or entomological by-products used for extracting chitin.

According to one embodiment, the raw material used in the method according to the present invention comprises marine by-products, preferably crustaceans, prawns, crabs, krill, more preferably crustacean shells and heads; according to one particular embodiment of the invention, the raw material is obtained from cephalopods, preferably squid or cuttlefish.

According to one embodiment, the raw material used in the method according to the present invention comprises entomological by-products, preferably from beetles such as the Tenebrio molitor beetle, hymenoptera such as the Hermetia illucens fly, more preferably insect shells and heads.

The raw material preparation operation should be suitable for retaining the qualities thereof while meeting the requirements of the method.

According to one embodiment of the present invention, the raw material preparation comprises cleaning, drying and/or grinding operations.

According to one embodiment, the raw material is cleaned with water.

According to one embodiment, the raw material is dried from 1 hour to 36 hours preferably for approximately 18 hours, preferably in ventilated air, preferably at a temperature of 5 to 35° C., more preferably of approximately 12° C. According to one embodiment, the raw material is ground to obtain fragments having a maximum diameter equal to approximately 10 mm, preferably having a diameter less than approximately 1 mm.

According to one embodiment, the raw material, preferably prepared by cleaning, drying and grinding, is stored prior to extraction at a temperature between −30 and −10° C., preferably at −20° C., preferably limiting the presence of oxygen.

Reaction Medium

The term “reaction medium”, according to the present invention, denotes the medium wherein the enzymatic hydrolysis reaction in an acid medium takes place.

The reaction medium preparation should account for the enzyme activity conditions used such as the temperature, solvent and pH. The selection of these conditions makes it possible to optimize the reaction time and yields.

According to one embodiment, the reaction medium is maintained during the enzymatic hydrolysis at a temperature between 2 and 80° C., preferably between 35 and 45° C., more preferably from approximately 37 to approximately 40° C.

According to one embodiment, the temperature of the reaction medium is adapted to the enzyme used so that said enzyme has a quasi-optimal activity throughout the enzymatic hydrolysis.

According to one embodiment, the reaction medium is maintained during the enzymatic hydrolysis at a temperature in the range T_{enz}±0 to 20° C., preferably T_{enz}±0 to 15° C., preferably T_{enz}±0 to 10° C., where T_{enz} is the temperature at which the enzyme exhibits maximum activity. The temperature selected should not induce the degradation of the enzyme or inhibit the action thereof. Advantageously, the temperature of the reaction medium is less than T_{enz} so as to limit energy consumption.

According to one embodiment, the pH of the reaction medium is 0.5 to 6.5, preferably from 1.8 to 3.8, more preferably from approximately 1.9 to approximately 2.1. If the enzyme is pepsin, the pH of the reaction medium is preferably from approximately 1.9 to approximately 2.1.

According to one embodiment, the pH of the reaction medium is acidic and the value thereof is adapted to the enzyme used so that said enzyme has an optimal activity.

According to one embodiment, the pH of the reaction medium is in the range pH_{enz}±2, preferably pH_{enz}±1.5, preferably pH_{enz}±1, where pH_{enz} is the pH at which the enzyme exhibits maximum activity. The pH selected should be acidic to ensure that the chitin extraction yield is sufficient.

According to one embodiment, the reaction medium is ready for use when the temperature and pH conditions selected for the enzymatic hydrolysis reaction are stabilized.

According to a first embodiment, the reaction medium comprises at least one acid. According to a second embodiment, the reaction medium further comprises a solvent such as water or an aqueous solution.

According to one embodiment of the present invention, the acid used is preferably a dietary acid, preferably phosphoric acid or formic acid.

When the acid used in the enzymatic hydrolysis step is a dietary acid, the products extracted by means of the method according to the present invention offer the advantage of being suitable for easier use in the food and cosmetic sectors.

According to one embodiment, the acid concentration in the reaction medium is from 0.1 to 6 mol·L⁻¹, preferably from 0.8 to 2.8 mol·L⁻¹, more preferably from 0.9 to 1 mol·L⁻¹.

According to one embodiment, the acid concentration in the reaction medium is adapted to the mineral content of the raw material used so that the pH of the reaction medium is acidic and remains constant throughout the enzymatic hydrolysis.

Enzyme

According to one embodiment, the enzyme used in the present invention is an active enzyme in an acid medium, preferably a protease having a broad spectrum of activity in an acid medium, preferably pepsin or a stable acid protease.

According to one embodiment, the enzyme concentration in the reaction medium is adapted to the protein content of the raw material used. According to one embodiment, the enzyme concentration is 0.1 to 75%, preferably 5 to 30%, more preferably from approximately 23 to approximately 27% by mass in relation to the protein mass estimated in the raw material.

Reaction Conditions

According to one embodiment, the raw material is mixed with the reaction medium and the resulting mixture is optionally homogenized by stirring for 0 to 30 minutes, preferably for 3 to 10 minutes, more preferably for approximately 5 minutes.

According to one embodiment, the ratio between the weight of raw material prepared and the volume of reaction medium is 1:60 to 2:1, preferably 1:7 to 1:3, more preferably equal to 1:5.

According to one embodiment, the ratio between the weight of raw material prepared and the volume of reaction medium is adapted to the size of the fragments of raw material prepared. In particular, account is taken of the fact that, when the size of the fragments of raw material decreases, solvent absorption increases and that, consequently, it is necessary to increase the volume of reaction medium.

Adding raw material into the acid reaction medium may give rise to the formation of foam due to the production of carbon dioxide due to the presence of calcium carbonate in the exoskeleton of crustaceans and insects. According to one embodiment, the vessel used for performing enzymatic hydrolysis has a suitable volume for preventing the foam liable to form from overflowing. The risk of foam production increases when the temperature of the acid before mixing increases.

According to one embodiment, the temperature of the reaction medium before adding the raw material is 5 to 65° C., preferably 20 to 30° C., more preferably approximately 25° C. In this embodiment, the temperature of the reaction medium is selected in order to be less than the temperature at which the enzymatic hydrolysis is to be conducted, so as to limit foam formation when adding raw material.

According to a first embodiment, the enzyme is added directly into the homogenized reaction medium optionally containing the raw material.

According to a second embodiment, the enzyme is solubilized in water, or in a solution, preferably an aqueous solution, and is added into the homogenized reaction medium containing the raw material.

According to one embodiment, the enzymatic hydrolysis reaction is performed under stirring so as to optimize the contact between the raw material and the enzyme.

According to one embodiment, the initial pH and temperature conditions of the reaction medium are kept constant throughout the enzymatic hydrolysis reaction. According to a further embodiment, the initial pH and/or temperature conditions of the reaction medium are not kept constant throughout the enzymatic hydrolysis reaction.

According to one embodiment, the enzymatic hydrolysis reaction is performed in a reactor equipped with a device for regulating the temperature. According to a first embodiment, said reactor is a double-jacket reactor wherein a heat transfer fluid circulates, the temperature of said fluid being possible to control. According to a second embodiment, said reactor is equipped with a heating resistor, the temperature of said resistor being suitable for being controlled.

According to a first embodiment, the pH is stable throughout the enzymatic hydrolysis. According to a second embodiment, the pH is adjusted, during the enzymatic hydrolysis reaction, to the pKa value between the acid used and calcium carbonate by adding a concentrated acid solution, the acid being the same as that used in the reaction medium.

According to one embodiment, the duration of the enzymatic hydrolysis is from 30 minutes to 24 hours, preferably from 1 hour to 12 hours, preferably from 3 hours to 8 hours, more preferably approximately 6 hours.

According to one embodiment, the duration of the enzymatic hydrolysis is adapted to the activity of the enzyme used for conducting the enzymatic hydrolysis reaction, to the acid used and to the raw material.

According to one embodiment, the duration of the enzymatic hydrolysis is adapted according to the features sought for the end products, such as the degree of purity, the degree of polymerization and the degree of acetylation.

According to one embodiment, the enzymatic reaction produces a reaction liquor comprising soluble and insoluble portions.

Products Separation

According to one embodiment, the soluble and insoluble portions of the reaction liquor are separated by any suitable means known to those skilled in the art.

According to a first embodiment, the soluble and insoluble portions are separated by filtration. According to one embodiment, the filtration is performed by a filtration system preserving the integrity of the structures of the extracted compounds. According to a further embodiment, the filtration is performed by a membrane press filtration system. According to a further embodiment, the filtration is performed on a filter cloth, preferably on bolting cloth.

According to a second embodiment, the soluble and insoluble portions are separated by centrifugation.

According to one embodiment, the insoluble portion of the reaction liquor very predominantly contains chitins and the soluble portion contains various compounds such as lipids, pigments, sugars, mineral salts, amino acids or peptides.

According to one embodiment, the insoluble portion is rinsed using a solvent. According to a first embodiment, the solvent is water or an aqueous solution. This embodiment is preferred if the chitins are subsequently used for dietary applications. According to a second embodiment, the insoluble portion is first rinsed with water or an aqueous solution and then with a bleaching agent such as hydrogen peroxide, sodium hypochlorite or potassium persulphate and is rinsed again with water or an aqueous solution. This second embodiment is preferred if bleaching of the chitins is sought. In this embodiment, the bleaching agents used are in accordance with legislation.

Chitins are very hygroscopic substances, wherein the biological activity may be degraded by an increase in temperature.

According to one embodiment, the filtered and rinsed insoluble portion is then dried for 8 to 16 hours, preferably for approximately 12 hours, in an oven wherein the temperature is preferably less than 100° C., preferably between 50 and 95° C., more preferably approximately 90° C.

According to one embodiment, the filtered insoluble portion is neutralized with sodium hydroxide. According to one embodiment, the insoluble portion is freeze-dried.

According to one embodiment, the dried and/or freeze-dried insoluble portion is packaged in vessels such as glass or plastic bottles or vacuum pouches and stored preferably at ambient temperature in a dry place. According to one particular embodiment, the insoluble portion (chitin) is stored at a temperature less than ambient temperature, preferably at a temperature from −30 to 0° C., more preferably from −20 to −10° C., more preferably at approximately −20° C.

According to a first embodiment, the soluble portion is centrifuged. According to a second embodiment, the soluble portion is dialysed and ultrafiltered. According to a third embodiment, the compounds from the neutralized soluble portion are extracted using organic solvents. The organic or aqueous solvents are then evaporated to be able to obtain the compounds of interest.

The technique for processing the soluble phase is dependent on the nature of the compounds to be recovered.

Extraction Yields

Controlling the reaction medium (enzyme concentration, pH and temperature) according to the raw material used makes it possible to control the yield and the biochemical and physicochemical characteristics of the chitins obtained. Theoretically, by extending the hydrolysis time, the degree of polymerization tends to be reduced.

The mass extraction yield of the insoluble portions (Yd) is dependent on the nature of the raw material, acid and enzyme used and is calculated using the following formula:

Yd%=100*(dried insoluble weight)/(dry raw material weight)

According to one embodiment, the insoluble portion predominantly contains chitins and residual proteins and minerals not removed during the enzymatic hydrolysis reaction.

Applying conventional chemical extraction treatment to the insoluble portions obtained using the method according to the present invention makes it possible to estimate the residual impurity content in the insoluble portion. Indeed, this treatment is suitable for removing the majority of residual proteins and minerals.

The degree of chitin purity (D° purity) is estimated by means of gravimetry, by measuring the mass of the insoluble sample before and after treating the insoluble portions with 1.25 mol·L⁻¹ sodium hydroxide at 90° C. for 1 hour. As mentioned above, this treatment is suitable for removing residual proteins and minerals. The estimated degree of purity is calculated using the following formula:

D°purity=100*[(mass of insoluble portion after treatment)/(mass of insoluble portion before treatment)]

According to one embodiment, the estimated degree of chitin purity (D°purity) is greater than 75%, preferably greater than 80%, more preferably greater than 85%, more preferably greater than 90%.

According to one embodiment, the mass residual protein content in the dried insoluble portion is less than 20%, preferably less than 15%, preferably less than 10%, more preferably less than 5%.

According to one embodiment, the mass proportion of proteins removed by the method according to the present invention is greater than 80%, preferably greater than 85%, more preferably greater than 90%, more preferably greater than 95%.

According to one embodiment, the weight amount of residual mineral in the dried insoluble portion is less than 5%, preferably less than 3%, more preferably less than 1%.

According to one embodiment, the weight amount of minerals removed by the method according to the present invention is greater than 95%, preferably greater than 97%, more preferably greater than 99%.

According to one embodiment, an additional bleaching operation is performed on the insoluble portion, for removing pigments along with a portion of the residual proteins and minerals.

According to one embodiment, an additional deacetylation operation is performed on the insoluble portion, for producing chitosan and removing a portion of the residual proteins.

Features of the Chitins Extracted

According to one embodiment, the chitins extracted using the method according to the present invention may be used as is or converted into chitosan, chitin oligomers, chitosan oligomers or optionally N-acetylated glucosamines.

The method according to the present invention is suitable for obtaining a wide range of chitin quality in respect of the degree of purity and polymerization. The other features (pattern distribution, α, β and γ form) are dependent on the nature of the raw material and not on the features of the method according to the invention.

According to one embodiment, the chitins extracted using the method according to the present invention are similar in form to the natural form of chitin. In other words, the chitins extracted using the method according to the present invention are not denatured or only slightly denatured in relation to natural chitin.

According to one embodiment, the estimated degree of purity of the chitins extracted using the method according to the present invention is greater than 85%, preferably greater than 90%, more preferably greater than 95%.

The degree of purity of the chitins obtained using the method according to the present invention is sufficient to be able to convert said chitin in the form of chitosan, chitin oligomers, chitosan oligomers and glucosamines.

According to one embodiment, the degree of polymerization of the chitins is estimated by calculating based on the average molecular mass of said chitins. According to one embodiment, the average molecular mass of the chitins is estimated by calculating based on the intrinsic viscosity. The intrinsic viscosity may be determined using the method described by Poirier et al. (Poirier, M. and Charlet, G., Carbohydrate Polymers, 2002, 50, 363-370).

According to one embodiment, the degree of polymerization of the chitins extracted using the method according to the present invention is from 1.10³ to 1.10⁹, preferably from 1.10⁴ to 1.10⁷, more preferably from 1.10⁵ to 1.10⁶.

According to one embodiment, the degree of acetylation of the chitins extracted using the method according to the present invention is from 80% to 100%, preferably from 90% to 98%, more preferably from 95% to 97%.

According to one embodiment, the crystallinity index of the chitins extracted using the method according to the present invention is from 10% to 70%, preferably from 20% to 50%, more preferably from 30% to 40%.

Soluble Compounds

According to one embodiment, the soluble substances extracted using the method according to the present invention may be peptides, pigments, sugars and mineral salts. The use of dietary acid in this method enables the use of these compounds in the food, dietetic and nutraceutical sectors.

The present invention thus offers the advantage of limiting the quantity of waste since all substances other that chitin extracted using the method according to the invention can also be used or recovered.

According to one embodiment, the pigments extracted using the method according to the present invention are astaxanthin.

### BRIEF DESCRIPTION OF THE DRAWINGS

FIG. 1 represents a scheme of the method for extracting chitin according to the invention.

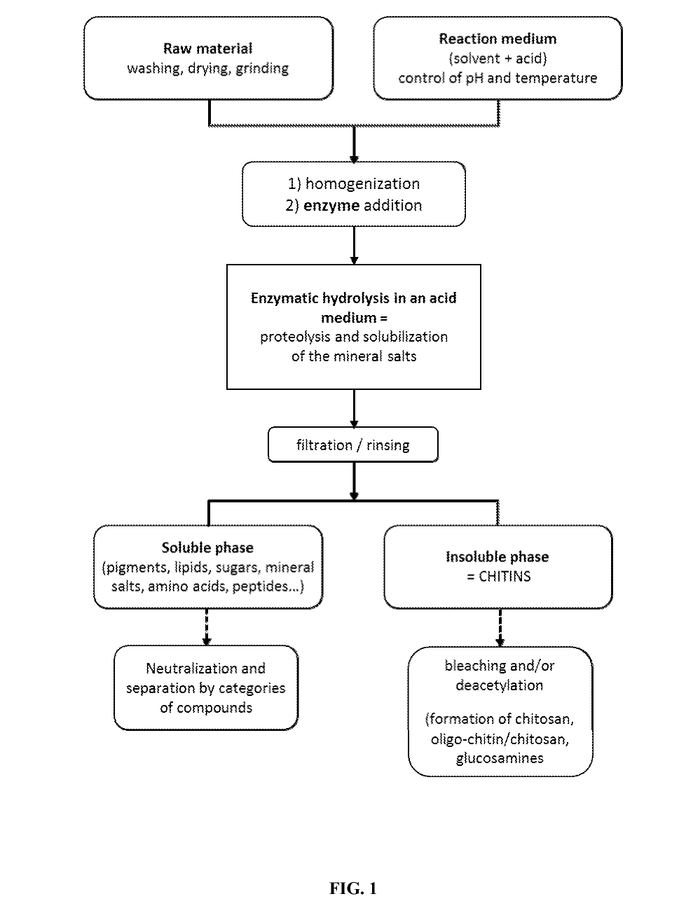

### EXAMPLES

The invention will be understood more clearly on reading the following example, illustrating the present invention in a non-limiting fashion

### Example 1

### Enzymatic Hydrolysis Using Pepsin in the Presence of Phosphoric Acid

Materials

The raw material used is the raw Panaeus vannamei prawn exoskeleton. The raw material is dried at 12° C. in ventilated air and ground to produce fragments less than 1 mm in size. The raw material prepared is stored at −20° C. in a vacuum.

The reagent used to maintain the acidic pH is phosphoric acid. The acid concentration is calculated according to the initial mineral content in the raw material prepared. For an initial mineral content of 25% in weight relative to the weight of dry raw material, a 0.94 mol·L⁻¹ phosphoric acid solution is used to keep the pH of the reaction medium around 2.

The acid protease used is pepsin (CAS 9001-75-6, supplier: Sigma, activity: 8112 U/mg). It is stored in powder form at +4° C. It is solubilised in distilled water for 15 min before being introduced into the reaction medium. The quantity of enzyme added in this example is equivalent to 25% of the estimated protein mass in the initial raw material. In this way, for a sample of 5 g of raw material having a moisture content of approximately 15% and a protein content of close to 40%, this is equivalent to 8.5% of enzyme in relation to the raw material, i.e. a quantity of pepsin of 0.43 g.

Protocol

5 g of raw material, prepared as described above, is weighed. The composition of the dry extract is determined according to the analytical methods described below.

A 0.94 mol·L⁻¹ phosphoric acid solution (25 mL) is preheated to 30° C. and added to the raw material. The mixture is stirred for 5 min so that it homogenises. The pH measured with a pH-meter should be stable and be between 1.9 and 2.1.

Pepsin (0.43 g), previously solubilised in 1 mL of water, is added to the reaction medium. The mixture is heated to 40° C. on a hot plate and incubated in an oven kept at 40° C.±1° C.

After 6 hours of incubation, the mixture is filtered on bolting cloth and rinsed with plenty of distilled water. The retentate is resuspended in distilled water, the mixture is stirred for 10 min before being filtered and rinsed again with water. The solid fraction obtained is transferred into a cup and dried overnight at 90° C. in an oven. The mass of dry extract obtained (m=1.29 g) is suitable for calculating the extraction yield, i.e. 30.26% w/w.

Analyses

The moisture content of the sample is measured by means of gravimetry, by measuring the mass of the sample before and after being placed overnight at 105° C.

The mineral content is determined by means of gravimetry, by measuring the mass of the sample before and after incineration at 600° C. for 6 hours.

The protein content is estimated by means of gas chromatography by assaying the total amino acids. It can also be measured by means of a colorimetric assay (Lowry, BSA, Bradford or Coomassie blue) or by means of a Kjeldahl assay.

The chitin content can be measured by means of gravimetry, by measuring the mass of the sample before and after the following treatments:
for the raw material: treatment for 60 minutes with 1N HCl at ambient temperature, followed by 1.25N NaOH at 90° C. for 120 minutes and finally bleaching with 33% hydrogen peroxide and acetone;
for the hydrolysis products, the treatment is limited to a treatment with 1.25 N NaOH at 90° C. for one hour.

The molecular mass of the chitins is estimated by calculating based on the intrinsic viscosity. The intrinsic viscosity can be determined using the method described by Poirier et al., which is based on the Mark-Houwink equation (Poirier, M. and Charlet, G., Carbohydrate Polymers, 2002, 50, 363-370). In this way, the intrinsic viscosity was determined by measuring the reduced viscosity using solutions of various chitin concentrations in N,N-dimethylacetamide containing 5% LiCl. The apparatus used is an Ubbelohde capillary viscometer. The viscometer constant K is 0.3 cSt/s. The measurement volume is 15 mL.

The degree of polymerization is calculated using the molecular mass of the chitins.

The degree of acetylation is estimated by means of protein liquid NMR, according to the method described by Einbu A., Varum K., 2008. Chitin (20 mg) is solubilized in 1 mL of DC1 (7.6N in D₂O, Euriso-top) with magnetic stirring at ambient temperature for 5 hours. The ¹H NMR analysis is performed at 300° K using a Bruker ALS300 spectrometer (300 MHz, reference TMSP 0.00 ppm). The degree of acetylation is then calculated based on the intensity of the characteristic proton NMR signals, according to the formula given by Einbu et al.

The crystallinity index is determined by means of X-ray diffraction. The diffractometer used is a Bruker-axs D8 Discover (Karlsruhe, Germany). Radiation is produced in a copper tube (Cu Kα₁=1.5405 Å) and the beams produced are recorded every 10 min. Using the spectra obtained, the method for calculating the crystallinity index is based on the ratio between the areas of the crystalline zones over the total area (Osario-Madrazo A., David L., Trombotto S., Lucas J. M., Peniche-Covas C. and Domard A., Carbohydrate Polymers, 2011, 83, 1730-1739).

Results and Discussion

After 6 hours of enzymatic hydrolysis with pepsin in the presence of phosphoric acid, the extraction yield is 30.26±0.32% w/w. The composition of the dry extract obtained can be compared to that of the fully dried raw material or the prepared raw material used in this example (table 1):

TABLE 1

| | mois- | | | | | |
|---|---|---|---|---|---|---|
| | ture | minerals | proteins | chitin | lipids | sugars |
| fully dry | | | | | | |
| raw | | | | | | |
| material: | | | | | | |
| % by mass | 0% | 25% | 40% | 30% | ND | ND |
| prepared | | | | | | |
| raw | | | | | | |
| material: | | | | | | |
| % by mass | 14.55% | 21.25% | 34% | 25.5% | 3.5% | 1.2% |
| dry | | | | | | |
| extract: | | | | | | |
| % by mass | 0% | 0.99 | 10.98 | 88.42 | ND | ND |
| | | (±0.03%) | (±1.01%) | (±1.22%) | | |
| per 100 g | 0 g | 0.30 g | 3.32 g | 26.76 g | ND | ND |
| of dry raw | | | | | | |
| material | | | | | | |

ND: not determined

In view of the composition of the dry raw material, the quantities of minerals and proteins removed using the method are 98.5% and 91.7%, respectively.

The residual mineral and protein contents (table 1) are those found in the unprocessed end product, without a bleaching step. Applying a bleaching agent or washing with sodium hydroxide enhances the degree of purity.

The degree of acetylation measured by NMR is, in this example, in the region of 95%. The molecular weight of this sample is in the region of 10⁵ to 10⁶ g/mol and the crystallinity index 35%. These features are similar to those of native chitin.

The performances of this example can be enhanced by increasing the quantity of pepsin used. In this way, the experiment was conducted with a pepsin concentration of 41% with respect to the quantity of proteins present in the raw material, instead of 25% previously. The degree of chitin purity increases (96.78% instead of 88.42%) as the deproteinization is enhanced (92.00% of proteins removed) along with the demineralization (99.23% of minerals removed).

1. A method for the enzymatic extraction of chitin, wherein said method is carried out in a single step, wherein chitin is obtained by the enzymatic hydrolyzis of raw material constituted by animal biomass comprising chitin, said enzymatic hydrolyzis using an active enzyme in an acid medium.

2. A method according to claim 1, wherein said single step is an enzymatic hydrolysis for deproteinizing and demineralizing said raw material simultaneously.

3. A method according to claim 1, wherein said enzyme active in an acid medium is a protease having a broad spectrum of activity in an acid medium, preferably pepsin or a stable acid protease.

4. A method according to claim 1, wherein the enzyme concentration used for hydrolysis is 0.1 to 75%, preferably 5 to 30%, more preferably from approximately 23 to approximately 27% in weight relative to the estimated weight of the protein in the raw material.

5. A method according to claim 1, wherein the acid medium is obtained by means of the presence of an acid, preferably a dietary acid, more preferably phosphoric acid or formic acid.

6. A method according to claim 1, wherein animal biomass comprising chitin comprises marine by-products, preferably marine by-products obtained from crustaceans, preferably prawns, crabs or krill, or from cephalopods, preferably squid or cuttlefish.

7. A method according to claim 1, wherein said animal biomass comprising chitin comprises insect by-products, preferably insect by-products obtained from beetles or hymenoptera.

8. A method according to claim 1, further comprising operations for washing, drying and/or grinding the raw material, preferably water washing, cold drying and/or grinding operations.

9. A method according to claim 1, further comprising reaction medium treatment operations at the end of the enzymatic hydrolyzis, said operations comprising operations for separating the solid and liquid phases, rinsing and/or drying the insoluble portion.

10. A method for optimizing the method for the enzymatic extraction of chitin described in claim 1, wherein said method comprises at least one of the following steps:
a) selecting the pH of the acid medium in the range pHenz±2, preferably pHenz±1.5, preferably pHenz±1, where pHenz is the pH at which the enzyme exhibits maximum activity,
b) electing the temperature of the acid medium in the range Tenz±20° C., preferably Tenz±15° C., preferably Tenz±10° C., where Tenz is the temperature at which the enzyme exhibits maximum activity,
c) determining the mineral and protein content of the raw material,
d) calculating the acid concentration to be used in the reaction medium, according to the mineral content of the raw material, such that the pH is maintained throughout the enzymatic hydrolysis at the pH selected in step a),
e) calculating the proportion of enzyme to be used with respect to the protein content of the raw material,
f) determining the reaction time for obtaining chitin or the chitin derivatives sought.

11. Chitin that can be obtained by means of the method according to claim 1.

12. Chitosan that can be obtained by deacetylating chitin according to claim 11.

13. Composition comprising chitin according to claim 11.

14. A pharmaceutical composition comprising chitin according to claim 11.

15. A cosmetic composition comprising chitin according to claim 11.

16. A medical device comprising chitin according to claim 11.

17. A food product, nutraceutical composition, dietetic composition, food supplement or functional food comprising chitin according to claim 11.

18. A composition comprising chitin according to claim 11 for the use thereof in water treatment, filtration and/or depollution.

19. A texturing agent comprising chitin according to claim 11.

20. A method according to claim 2, wherein said enzyme active in an acid medium is a protease having a broad spectrum of activity in an acid medium, preferably pepsin or a stable acid protease.
